(19) United States
(12) Patent Application Publication
(10) Pub. No.: US 2015/0008193 A1
(43) Pub. Date: Jan. 8, 2015

(54) Systems and Methods for Extracting Particulate from Raw Slurry Material

(71) Applicant: DARITECH, INC., Lynden, WA (US)

(72) Inventor: David DeWaard, Lynden, WA (US)

(21) Appl. No.: 14/322,858

(22) Filed: Jul. 2, 2014

Related U.S. Application Data
(60) Provisional application No. 61/843,307, filed on Jul. 5, 2013.

(51) Int. Cl. B01D 33/46; C02F 1/00; B01D 33/067; A01K 1/015; B01D 33/48

(52) U.S. Cl. CPC B01D 33/466; A01K 1/0154; B01D 33/48; B01D 33/067; C02F 1/004
USPC 210/784; 210/396; 210/394

(57) ABSTRACT

A separation system for separating solids from a slurry of waste material employs first and second separator assemblies. The first separator assembly has a main housing and a perforated drum supported for rotation relative to the main housing. The second separator assembly has a barrel member and an auger blade supported for rotation relative to the barrel member. The main housing is fixed relative to the barrel member such that rotation of the perforated drum removes a first solids portion from the slurry of waste material and rotation of the auger member removes a second solids portion from the slurry of waste material.

### RELATED APPLICATIONS

This application (Attorney's Ref. No. P217974) claims benefit of U.S. Provisional Application Ser. No. 61/843,307 filed Jul. 5, 2013, the contents of which are incorporated herein by reference.

### TECHNICAL FIELD

The present invention relates to the extraction of solid particulates from raw slurry material and, in particular, to the extraction of relatively small, heavy solid particulates such as sand from raw slurry material comprising at least water, small, relatively heavy particulate material such as sand, and small, relatively light particulate material such as fibers.

### BACKGROUND

In many situations, it is desirable to separate a slurry of raw material into constituent solid and liquid components. For example, while the general composition of municipal waste may be known, any particular gallon of municipal waste may contain a variety of unknown solid or liquid components. Before municipal waste can be introduced into the environment, it is typically processed to remove at least a portion of the liquid or solid components thereof. Municipal waste is thus typically processed in a variety of stages designed to remove liquid and solid materials that might be unsuitable for discharge into the environment.

Modern animal husbandry operations such as dairy farms represent another example of a system in which the processing of a slurry of raw material to remove solid particulates is advantageous. The present invention is of particular significance in the context of processing waste from a dairy farm, and that application of the present invention will be described in detail herein. However, the principles of the present invention may be applied to any system in which a slurry of raw material is processed to remove solid components from the slurry.

Dairy farms often require the handling of relatively large numbers of animals in indoor facilities. For example, cows in a dairy operation are kept at least part of the day in stalls defining a stall resting surface. The stall resting surface should be covered with bedding material that is comfortable to lie on, provides uniform support, is cool in the summer, is non-abrasive, and provides confident footing during reclining and rising maneuvers. From the perspective of the operator of the dairy facility, bedding material should not be detrimental to the health of the cows or the quality of the milk produced by the cows. Sand has been proven to be advantageous as a bedding material and is commonly used in modern dairy operations.

When sand is used as a bedding material, the sand often becomes mixed with manure and other materials that collect within a dairy facility. When cleaning systems are used to remove manure from the diary facility, raw slurry material is formed containing rinse liquids, liquid manure, solid manure, relatively heavy solids such as sand, relatively light solids such as fibers and/or corn, and possibly other contaminants. The term “relatively heavy” is used herein to refer to a material with a density greater than that of water, while the term “relatively lighter” is used herein to refer to a material with a density less than that of water.

When possible, it is desirable to convert components of the raw slurry mixture to usable materials and/or reuse the components of the raw slurry mixture. In the context of a dairy facility, sand used as bedding material represents a cost. To reuse the sand as bedding material, the sand must be clean. On the other hand, if manure and other digestible materials are to be converted to energy using an anaerobic digester, removal of non-digestible materials such as sand allows the anaerobic digester to operate more efficiently.

In addition, certain separation systems are highly effective at removing large amounts of relatively heavy particulate such as sand from a raw slurry. However, these separation systems employ a substantial amount turbulence that tends to cause smaller particulates (fine sand) to be suspended within rinse water. Accordingly, although a particulate material may be more dense than water, that relatively heavy particulate can carried with rinse water out of the separation system. Such relatively heavy particulate that is carried with rinse water out of a separation system will be said to have bypassed the separation system.

The present invention relates to the separation of raw slurry materials into its constituent components such as manure, waste and rinse liquids, relatively light fiber components such as corn, and relatively heavy non-digestible components such as sand. Removal of sand from the raw slurry material further forms a processed slurry (low sand content) that is more appropriate for further processing operations such as extraction of water, composting, and/or digesting.

### SUMMARY

The present invention may be embodied as a separation system for separating solids from a slurry of waste material, the separation system comprising first and second separator assemblies. The first separator assembly comprises a main housing and a perforated drum supported for rotation relative to the main housing. The second separator assembly comprises a barrel member and an auger blade supported for rotation relative to the barrel member. The main housing is fixed relative to the barrel member such that rotation of the perforated drum removes a first solids portion from the slurry of waste material and rotation of the auger member removes a second solids portion from the slurry of waste material.

The present invention may also be embodied as a method of separating solids from a slurry of waste material comprising the following steps. A perforated drum is supported for rotation relative to a main housing. An auger blade is supported for rotation relative to a barrel member. The main housing is supported relative to the barrel member. The perforated drum is rotated relative to the housing to remove a first solids portion from the slurry of waste material. The auger member is rotated relative to the barrel member to remove a second solids portion from the slurry of waste material.

The present invention may also be embodied as a separation system for separating solids from a slurry of waste material comprising first and second separator assemblies and a rinse system. The first separator assembly comprises a main housing, a perforated drum, and a drum motor for causing axial rotation of the perforated drum relative to the main housing. The second separator assembly comprises a barrel member, an auger shaft, an auger blade extending from the auger shaft, and a barrel motor for causing axial rotation of the auger shaft relative to the barrel member. The rinse system mixes rinse liquid with the slurry of waste material within the perforated drum. Rotation of the perforated drum removes a first solids portion from the slurry of waste material. The main housing is fixed relative to the barrel member to define an auger chamber arranged relative to the perforated drum such that at least a portion of the slurry of waste material and at least a portion of the rinse liquids enters the auger hopper. The auger blade is arranged at least partly within the auger hopper such that rotation of the auger member removes a second solids portion from the slurry of waste material.

### BRIEF DESCRIPTION OF THE DRAWINGS

FIG. 1 is a side elevation view of a first example separation system of the present invention;

FIG. 2 is a detailed section view of a first separator assembly of the first example separation system;

FIG. 2A is a section view taken along lines 2A-2A in FIG. 2;

FIG. 3 is a side elevation view of a second example separation system of the present invention;

FIG. 4 is a top plan view of the second example separation system;

FIG. 4A is a section view taken along lines 4A-4A in FIG. 4;

FIG. 5 is a partial section view of a processing system of the second example separation system;

FIG. 6 is a top plan view of a third example separation system of the present invention;

FIG. 7 is a top plan view of a fourth example separation system of the present invention;

FIG. 8 is a top plan view of a fifth example separation system of the present invention;

FIG. 9 is a top plan view of a sixth example separation system of the present invention;

FIG. 10 is a top plan view of a seventh example separation system of the present invention; and

FIG. 11 is a top plan view of an eighth example separation system of the present invention.

### DETAILED DESCRIPTION

The present invention relates to the removal of heavier than water particulate from a slurry of waste material the exact composition of which is unknown. The present invention is of particular significance in the context of the removal of sand from a slurry of waste material obtained from a dairy facility.

The present invention may be embodied in a number of different forms. In one basic form, the principles of the present invention may be implemented as a standalone separation system. The principles of the present invention may also be applied to a separation system used as a second stage in a larger two-stage separation system further comprising a first stage separator system. In the following detailed discussion section, the principles of the present invention will be described in the context of a standalone (single stage) separation system, as a second stage used as part of a larger two-stage separation system with a first stage formed of a first type of separation system, and as a second stage used as part of a larger two-stage separation system with a first stage formed of a second type of separation system. When used as a second stage as part of a larger two-stage separation system, the feed material processed by the second stage may be obtained at a first location in the first stage, at a second location in the first stage, and at both the first and second locations in the first stage.

Accordingly, a number of example implementations of a separation system of the present invention will be described in the following discussion.

### I. Example Standalone (Single Stage) Separation System

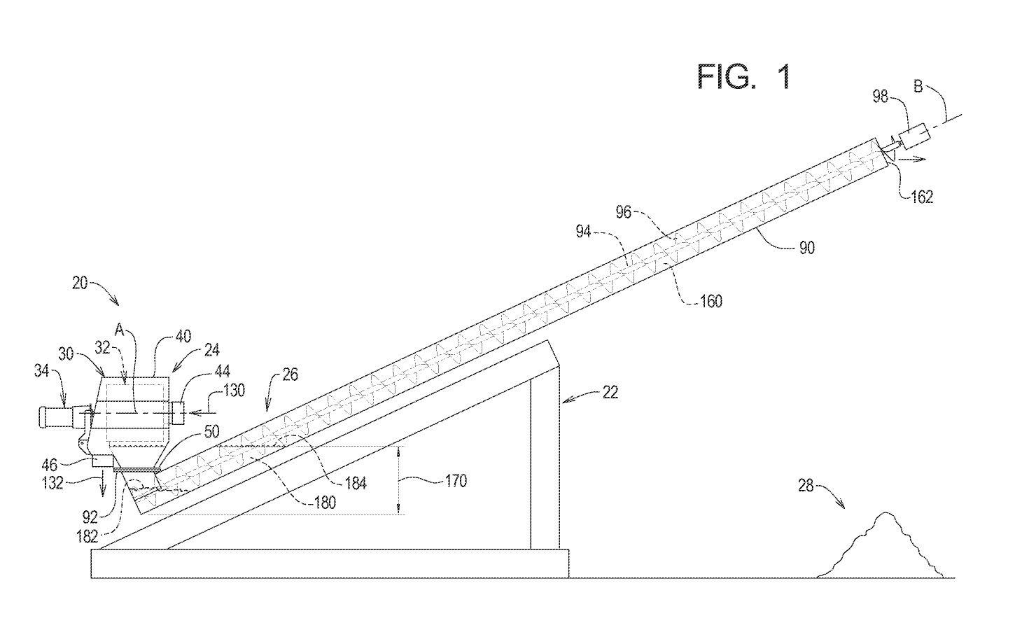

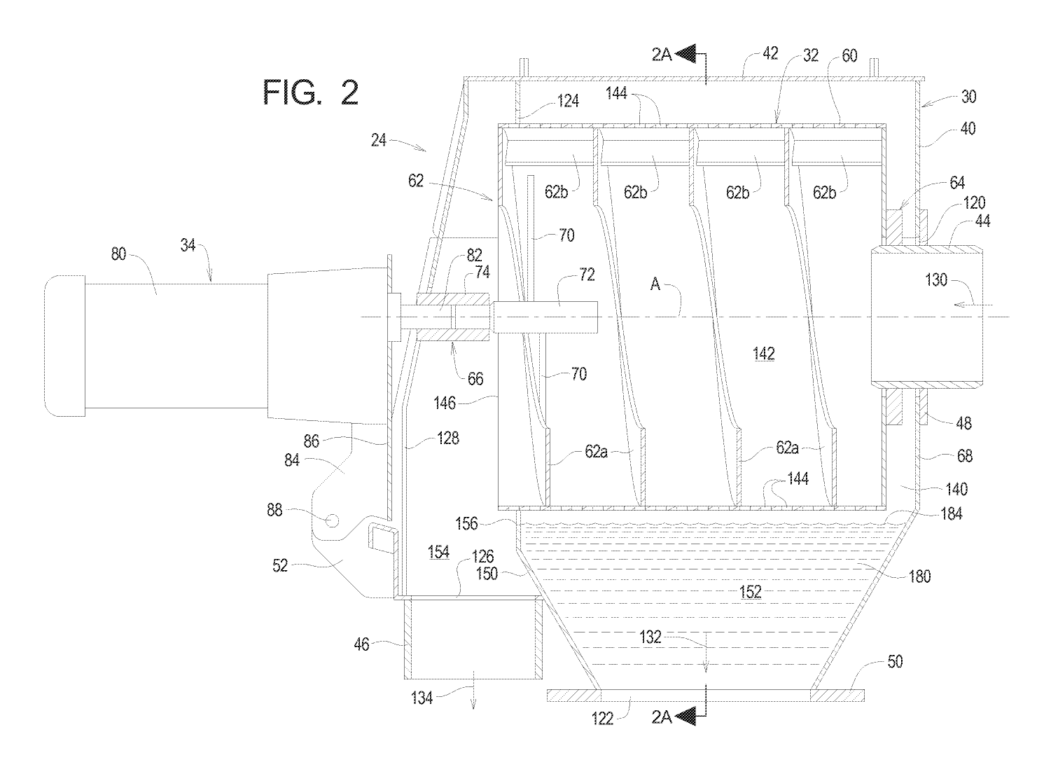

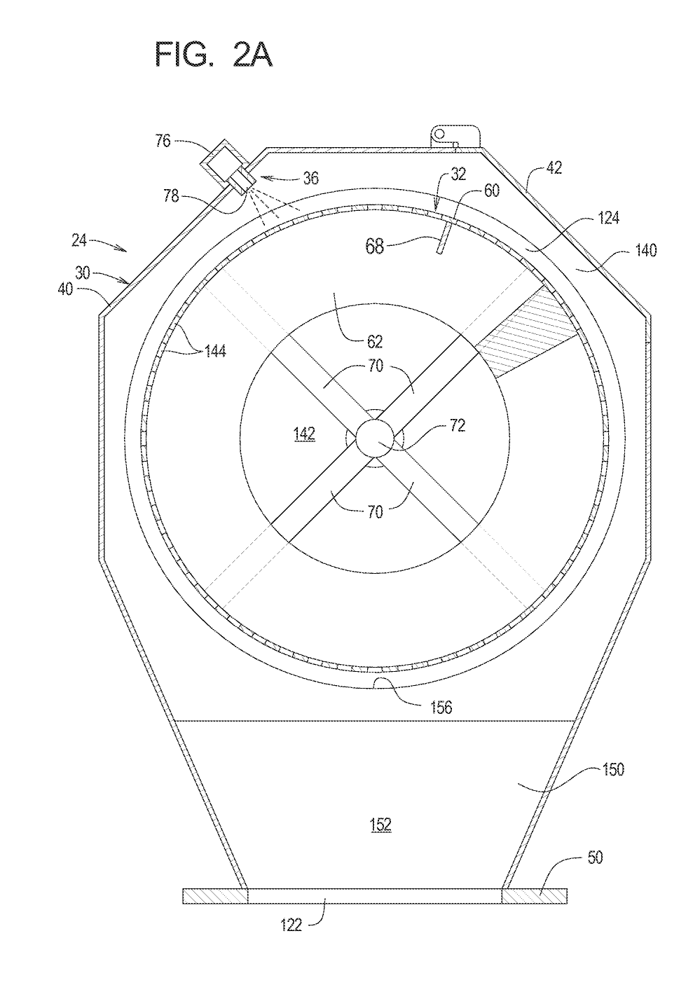

Referring initially to FIGS. 1 and 2 of the drawing, depicted therein is a first example separation system 20 of the present invention. The first example separation system 20 comprises a support frame 22, a first separator assembly 24, and a second separator assembly 26. A desired location 28 is defined by the second separator assembly 26 as will be described in detail below.

The first separator assembly 24 comprises a housing assembly 30, a drum assembly 32, a drum drive system 34, and a rinse system 36. The housing assembly 30 comprises a main housing 40, a housing cover 42, an inlet pipe 44, and outlet pipe 46, and a support plate 48. Formed on the main housing 40 are a first mounting flange 50 and a motor strut 52. The drum assembly 32 comprises a drum member 60, a blade structure 62, a bearing assembly 64, a coupler assembly 66, and an end wall 68. The coupler assembly 64 comprises spoke members 70, a coupler shaft 72, and a coupler member 74. The rinse system 36 comprises a supply of rinse liquid (not shown) such as water and a spray rod 76 defining a plurality of spray openings 78. The drum drive system 34 comprises a drum motor 80 having a drive shaft 82, a pivot plate 84, a mounting plate 86, and a pivot pin 88. The example second separator assembly 26 comprises a barrel member 90 on which is formed a second mounting flange 92, an auger shaft 94, an auger blade 96, and an auger motor 98.

With particular reference to FIG. 2 of the drawing, it can be seen that the first separator assembly 24 is formed as follows. The housing assembly 30 defines an inlet opening 120, a drain opening 122, an interior opening 124, an outlet opening 126, and a drive opening 128. The support plate 48 supports the inlet pipe 44 relative to the inlet opening 120 to define a main inlet 130. At least a portion of a slurry material processed by the example separator system 20 will enter the system 20 through the main inlet 130. Material entering the example separator system 20 through the main inlet 130 will be referred to as feed material. The drain opening 122 defines a drain outlet 132, and the first mounting flange 50 extends around the drain opening 122. The outlet pipe 46 is supported relative to the outlet opening 126 to define a main or first outlet 134.

The example drum member 60 is formed of a sheet of flat material rolled into a cylinder defining two open ends. The end wall 68 is secured to one of the open ends of the cylindrical drum member 60. FIG. 2 also shows that the bearing assembly 64 and the coupler assembly 66 support the drum member 60 for rotation within the housing assembly 30 about a drum axis A. In particular, the bearing assembly 64 is connected between the drum member 60 and the inlet pipe 44. The spoke members 70 of the coupler assembly 66 are rigidly attached at one end to the drum member 60 and at a second end to the coupler shaft 72 such that the coupler shaft 72 is substantially aligned with the drum axis A.

When the drum motor 80 is in an operational position as shown in FIG. 2, the drive shaft 82 is also aligned with drum axis A. With the drive drum motor 80 in the operational position, the coupler member 74 is arranged to extend between and couple the coupler shaft 72 to the drive shaft 82 such that the drive shaft 82 supports the drum member 60 and rotation of the drive shaft 82 is transmitted to the drum member 60 through the coupler member 74, coupler shaft 72, and spoke members 70. Operation of the drive drum motor 80 thus causes axial rotation of the drum member 60 about the drum axis A.

The example housing assembly 30 defines a housing chamber 140, and the example drum member 60 defines a drum chamber 142. The inlet pipe 44 supports the drum member 60 such that the drum member extends through the interior opening 124 and such that the main inlet 130 bypasses the housing chamber 140. Feed material entering the first example separation system 20 through the inlet pipe 44 thus first enters the drum chamber 142. As shown in FIG. 2, the drum member 60 defines perforations 144 that allow at least a portion of the material within the drum chamber 142 to enter the housing chamber 140. In addition, the open end of the drum member 60 opposite the end wall 68 and the main inlet 130 is uncovered such that the drum member 60 further defines a drum opening 146. The drum opening 146 also allows at least a portion of the feed material within the drum chamber 142 to enter the housing chamber 140.

FIG. 2 further shows that the main housing 40 further comprises a weir wall 150 that divides the housing chamber 140 below the drum member 60 into an auger hopper portion 152 and an outlet portion 154. In particular, the auger hopper portion 152 is arranged below the drum member 60 such that material flowing or dropping through the perforations 144 goes into the auger hopper portion 152. It should be noted that the perforations 144 are formed at regularly spaced locations over the entire surface of the drum member 60. In FIG. 2, however, the perforations 144 are only depicted at the top and bottom where the drum member 60 is shown in section view to avoid cluttering that drawing figure.

The outlet portion 154 is arranged below the drum opening 146 such that material flowing or dropping through the drum opening 146 goes into the outlet portion 154. The output portion 154 is arranged above the outlet pipe 46 to allow material within the output portion 154 to flow through the main outlet 134. The weir wall 150 defines a weir edge 156. The weir edge 156 of the weir wall 150 is located and shaped to allow material within the drain basin portion 152 to enter the outlet portion 154 as will be described in further detail below.

The example blade structure 62 comprises one or more blades 62a and one or more lifting plates 62b. The example blades 62a are helical and radially extend inwardly from the drum member 60 into the drum chamber 142 and towards the drum axis A. The example lifting plates 62b also radially extend inwardly from the drum member 60 into the drum chamber 142 and towards the drum axis A. However, the lifting plates 62b are substantially aligned with the drum axis A and extend between adjacent blades 62a of the blade structure 62 as perhaps best shown in FIG. 2. The example blade or blades 62a extend approximately 40% of the distance between the drum member 60 and the drum axis A. The example lifting plates 62b extend approximately 15% of the distance between the drum member 60 and the drum axis A. As will be explained in further detail below, the blade structure 62 and the lifting plates 62b are configured to displace solids within the drum chamber 142 from the main inlet 130 to the drum opening 146. The dimensions and shapes of blades 62a and the lifting plates 62b of the blade structure 62 may be determined based on the specific environment (composition of the feed material, flow rates, etc.) in which the first example separation system 20 is intended to operate.

In use as shown in FIG. 1, the first and second mounting flanges 50 and 92 are connected together using bolts, welding, or the like. The connection between the first and second mounting flanges 50 and 92 is desirably fluid tight. The example main housing 40 and barrel member 90 are configured such that, during normal use of the first example separation system 20, the drum axis A is desirably substantially horizontal, and the auger axis B extends at an angle with respect to the drum axis A.

FIG. 1 further illustrates that the barrel member 90 defines a barrel chamber 160. An upper end of the barrel member 90 is open to define an auger or second outlet 162 of the first example separation system 20. The length of the barrel member 90 and the angle between the drum axis A and the auger axis B are determined such that the second outlet 162 is arranged above the desired location 28. Where the first and second separator assemblies 24 and 26 are connected by the first and second flanges 50 and 92, the barrel chamber 160 and the drain basin portion 152 of the housing chamber 140 define an auger hopper 170 of the first example separation system 20. FIG. 1 also illustrates that the angle between the drum axis A and the auger axis B allows liquid 180 and sand 182 to collect in the auger hopper 170. The vertical location of the weir edge 156 of the weir wall 150 determines a level 184 of the liquid within the auger hopper 170.

The first example separation system 20 operates as follows. Feed material is introduced into the main inlet 130. In the context of a dairy facility, the feed material will typically comprise a mixture or combination of rinse liquids, liquid and solid animal waste, fiber material such as corn, and sand. The physical structures of larger fibers particles, such as solid animal waste and feed, are typically larger and less dense than the particles of sand.

The feed material flowing through the main inlet 130 will be deposited on the inner surface of the drum member 60 within the drum chamber 142. Then drum member 60 is then rotated by the drum drive system 34, agitating the feed material within the drum chamber 142. At the same time, the rinse liquid is sprayed through the spray openings 78 onto the outer surface of the drum such that the rinse liquid flows through the perforations 144 and onto the feed material within the drum chamber 142. When the feed material is agitated and rinsed, the smaller sand particles will typically be suspended in the rinse liquids and in the liquid portion of the feed material.

The perforations 144 are sized and dimensioned to prevent larger particles, such as fiber material and solid animal waste, from flowing from the drum chamber 142 into the drain basin portion 152 of the housing chamber 140 and thus into the auger hopper 170. However, liquids and heavier and smaller particles, such as sand, suspended in the liquids will pass through the perforations 144 and be carried by the liquids into the auger hopper 170. In addition, a relatively small amount of the relatively lighter smaller solids may pass through the perforations and into the auger hopper 170.

Rotation of the drum member 60 encourages the liquid portion of the feed material, relatively heavy particulates sand suspended in the liquid portion, and possibly some of the relatively smaller, lighter particulates such as fiber in the feed material to flow through the perforations 144 and into the auger hopper 170. With rotation of the drum member 60, the blade structure 62 will displace the portion of the feed material that has not passed through the perforations 144 out of the drum chamber 142 through the drum opening 146 and into the output portion 154 of the housing chamber 140. Any material flowing into the output portion 154 of the housing chamber 140 will flow through the main outlet 134 defined by the first example separation system 20. In practice, the blade structure 62 will displace the larger particles, such as fiber material and animal waste, through the drum opening 146 and subsequently through the main outlet 134.

Liquids 180, relatively heavy particulates such as sand 182, and possibly some of the relatively lighter particulates that pass through the perforations 144 will collect in the auger hopper 170. Eventually, the level 184 of the liquids 180 in the auger hopper 170 will reach the weir edge 156 of the weir wall 150. At this point, the liquids 180 will flow over the weir edge 156 from the auger hopper 170 into the outlet portion 154 and out of the first example separation system 20 through the main outlet 134.

However, the liquid 180 within the auger hopper 170 is relatively still (e.g, no or low agitation). Accordingly, sand 182 suspended within the liquid 180 will collect or settle at the bottom of the auger hopper 170 as shown in FIG. 1. At the same time, any relatively light, smaller particulates that passed through the perforations 144 will float to the top of the liquid 180 in the auger hopper 170 and will eventually also be carried over the weir edge 156, into the outlet portion 154, and through the main outlet 134.

Operation of the auger drive motor 98 causes rotation of the auger shaft 94. The auger blade 96 is a helical member that extends radially from the auger shaft 94. As the auger shaft 94 rotates, the auger blade 96 will displace the sand 182 within the auger hopper 170 up along the barrel chamber 160 and out of the second outlet 162 of the first example sand separation system 20. The auger blade 96 is typically rotated at a low speed to discourage agitation of the liquid 180 and sand 182 in the auger hopper 170 that might otherwise cause the sand 182 to become suspended within the liquid 180.

The drum motor 80 and the auger motor 98 may be operated together or independently. Either of these motors 80 and 98 may be operated continuously, periodically, asynchronously, and/or at irregular intervals. Further, a control system comprising one or more sensors may be provided. The sensors can be configured to generate signals indicative of fluid levels, solids levels, weight levels, or the like, and the control system can operate one or both of the motors 80 and/or 98 based on these signals.

In the first example separation system 20, the drum 60 containing the perforations 144 is formed by standard perforated sheets of sufficiently rigid metal to allow the sheets to be rolled and welded to form the cylindrical drum 60 as shown in FIG. 2. The sizes of the perforations 144 and diameter of the cylindrical drum member 60 will be determined based on the expected composition and flow rate of the feed material and any rinse liquids entering the drum chamber 142. Using standard sheets of perforated steel, the perforations 144 may be formed by 1/16 inch or 3/16 inch circular openings at standard spacings. The perforation may in any event be within a first range of 1/16 inch and 3/16 inch or within a second range of approximately 1/32 inch to ½ inch.

The rotational speed of the drum member 60 will also be determined by the composition and flow rate of the feed material through the main inlet 130. In the first example separation system 20, the drum member 60 is rotated at a drum rotation speed of approximately 20 rpm. The drum rotation speed is typically within a first range of approximately 15 to 25 rpm and in any event should be within a second range of approximately 5 to 35 rpm.

The exact angle between the drum axis A and the auger axis B is not critical, but is approximately 27.5 degrees in the example shown in FIG. 1. This angle is typically in a first range of approximately 20 to 40 degrees and in any event may be within a second range of approximately 5 to 80 degrees.

### II. Example Two-Stage Separation System

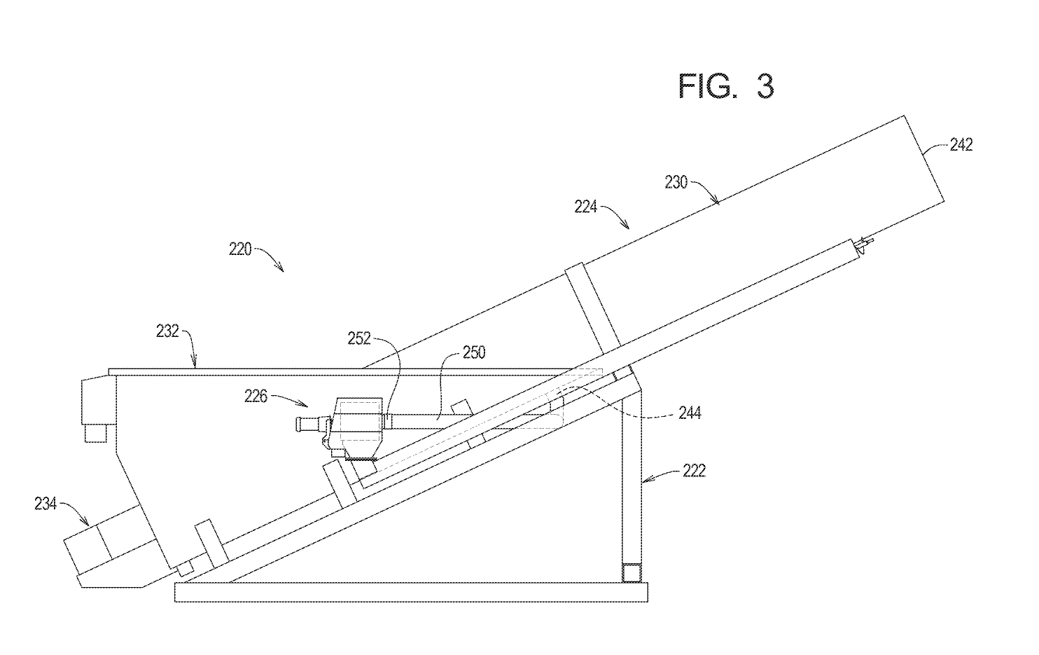

Turning now to FIGS. 3, 4, 4A, and 5, depicted at 220 therein is a second example separation system 220 constructed in accordance with, and embodying, the principles of the present invention. The second example separation system 220 comprises a support frame 222 that supports a first stage or primary separator 224 and a second stage or secondary separator 226.

The example first stage or primary separator 224 is disclosed in the Applicant's copending U.S. patent application Ser. Nos. 13/351,214 and 13/926,640, which are attached hereto as Exhibits A and B and incorporated herein by reference. The example second stage or secondary separator 226 is the first example separation system 20 described above. The first and second stage separators 224 and 226 will be described again herein only to that extent necessary for a complete understanding of the principles of the present invention.

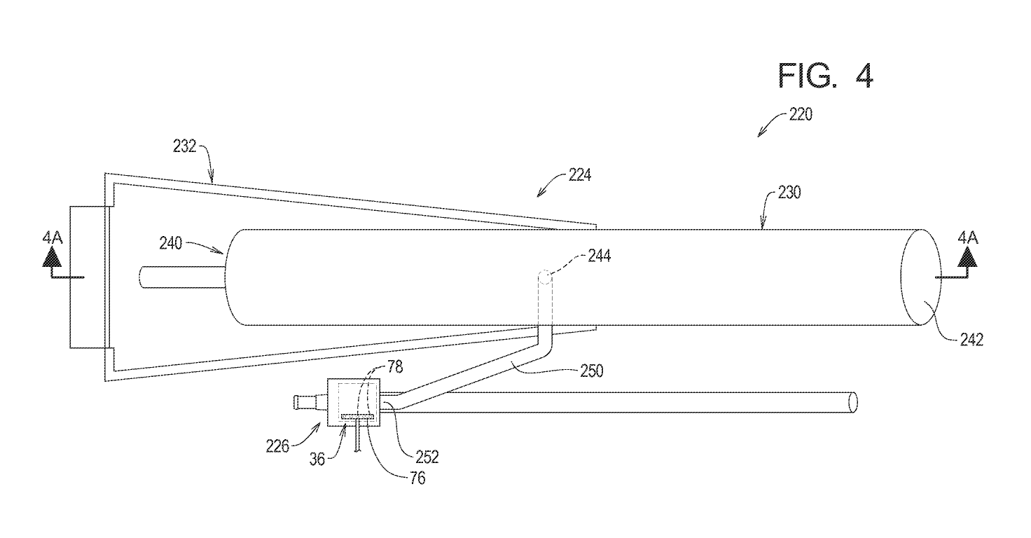

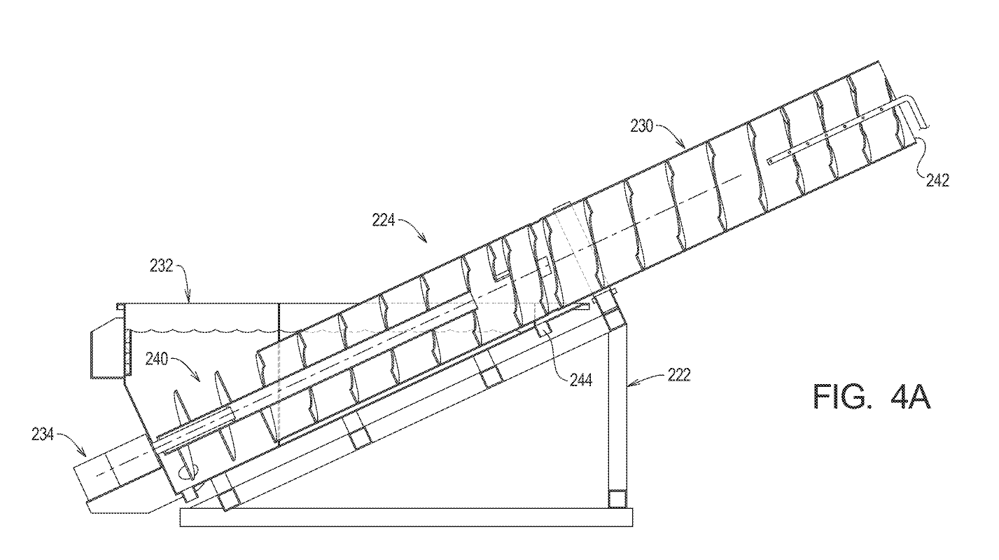

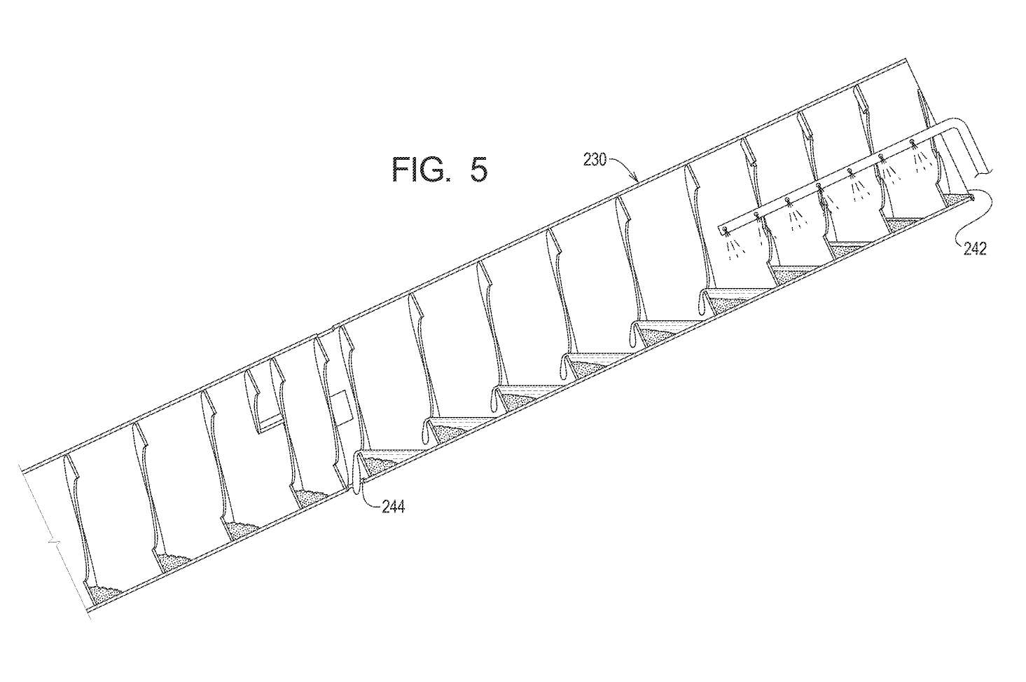

The first stage separator 224 comprises a primary processing system 230, a trough system 232, and a drive system 234. As perhaps best shown in FIGS. 4, 4A, and 5, the primary processing system 230 defines a primary inlet 240, a first primary outlet 242, and a second primary outlet 244. The primary inlet 240 is arranged such that, when the primary processing system 230 is rotated by the drive system 234, a processed portion of primary feed material contained in the trough system 232 is displaced from the primary inlet 240 towards the first primary outlet 242. In practice, relatively clean sand exits the primary processing system 230 through the first primary outlet 242.

As perhaps best shown in FIGS. 4A and 5, the second primary outlet 244 is arranged between the primary inlet 240 and the first primary outlet 242 such that a portion of the feed material processed by the first stage separator 224 flows out of the second primary outlet 244. In particular, when the primary feed material in the trough system 232 is obtained from a dairy facility, the primary feed material will comprise solid and liquid animal waste, contaminates such as fiber material, sand, and rinse water. Additional rinse water may be added to the primary feed material.

In the '214 and '640 applications, the Applicants noted that the second primary outlet 244 can be arranged to remove a portion of the primary feed material. The '214 application specifically noted that the primary processing system 230 and the second primary outlet 244 can be configured to prevent lighter particulates from flowing with rinse water back towards the trough system 232. More specifically, rinse water introduced in the primary processing system 230 tended to carry lighter particulate material, especially fiber material such as corn, back into the trough system 232. This lighter particulate material would float in the trough system 232, clogging the trough system 232 and reducing the effectiveness of the primary processing system 230. Removing such lighter particulate material from the primary processing system 230 through the second primary outlet 244 before these lighter particulate materials can flow back into the trough system 232, as generally shown in FIGS. 4, 4A, and 5, can alleviate clogging of the trough system 232 and thereby increase the effectiveness of the primary processing system 230.

However, the portion of the primary feed material removed through the second primary outlet 244 can also carry sand. In particular, the primary feed material being processed by the primary processing system 230 is agitated by rotation of the primary processing system 230, and smaller, lighter sand particles can become suspended in the liquids in the primary feed material and rinse water. These suspended sand particles can flow with the lighter particulate material and liquids out of the second primary outlet 244 instead of being carried up to the first primary outlet 242. The portion of the processed material removed from the primary processing system 230 through the second primary outlet will be referred to as the secondary feed material.

The secondary feed material will typically differ from the primary feed material in the relative concentration of relatively lighter particulates, such as fiber material, to relatively heavier particulates, such as sand. In particular, the secondary feed material will typically contain a much lower percentage of relatively heavier particulates and a much higher percentage of relatively lighter particulates than the primary feed material.

FIG. 4 illustrates that the second example separation system 220 comprises a transfer conduit 250 connected between the second primary outlet 244 and a secondary inlet 252 defined by the second stage separator 226. The secondary inlet 252 may be the same as the main inlet 130 of the first example separation system 20 described above. The secondary feed material will thus be processed in the same manner as the feed material processed by the first example separation system 20 to remove sand from the secondary feed material. The second stage separator 226 efficiently separates the secondary feed material into the heavier, smaller particulates (e.g., sand) and larger, lighter fiber particulates (e.g., corn). In particular, while the primary or first stage separator 224 is more effective at removing sand from the primary feed material, the second stage separator 226 is more effective at removing sand from the secondary feed material. The combination of the first and second stage separators 224 and 226 is thus highly efficient at removing sand from slurry material obtained from a dairy operation.

### III. Example Two-Stage Separation System

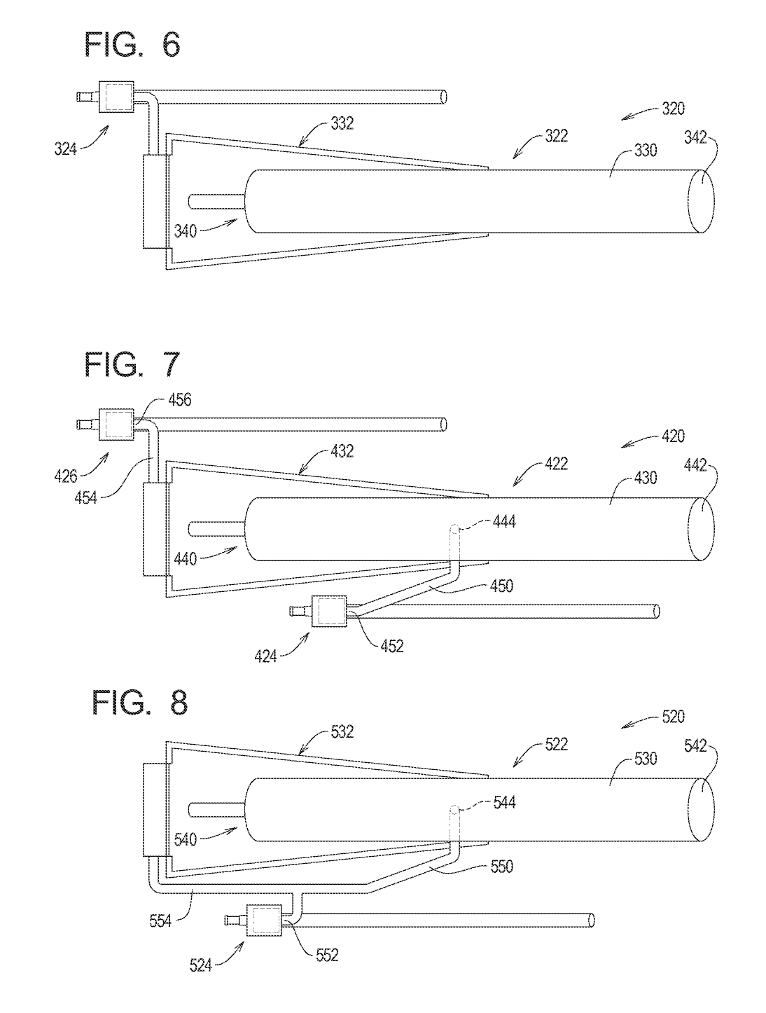

FIG. 6 illustrates a third example separation system 320 comprising a primary or first stage separator 322 and a secondary or second stage separator 324. Again, the example first stage or primary separator 322 is disclosed in the Applicant's copending U.S. patent application Ser. Nos. 13/351,214 and 13/926,640 and the example second stage or secondary separator 324 is the first example separation system 20 described above. The first and second stage separators 324 and 326 will be described again herein only to that extent necessary for a complete understanding of the principles of the present invention.

The first stage separator 322 comprises a processing system 330, a trough system 332, and a drive system (not visible in FIG. 6) and defines a primary inlet 340 and a first primary outlet 342. Again, relatively clean sand exits the processing system 330 through the first primary outlet 342. In the third example separation system 320, a portion of the primary feed material within the trough system 332 is removed and carried by a conduit 350 to a secondary inlet of the secondary or second stage separator 324. The portion of the primary feed material flowing through the conduit 350 will be referred to as secondary feed material and is removed from the top of the trough system 332. Because the secondary feed material is removed from the top of the trough system 332, the secondary feed material will typically contain a much lower percentage of relatively heavier particulates and a much higher percentage of relatively lighter particulates than the primary feed material.

The secondary inlet 352 may be the same as the main inlet 130 of the first example separation system 20 described above. The secondary feed material will thus be processed in the same manner as the feed material processed by the first example separation system 20 to remove sand from the secondary feed material. The second stage separator 324 efficiently separates the secondary feed material into the heavier, smaller particulates (e.g., sand) and larger, lighter particulates (e.g., corn). In particular, while the primary or first stage separator 322 is more effective at removing sand from the primary feed material, the second stage separator 324 is more effective at removing sand from the secondary feed material. The combination of the first and second stage separators 322 and 324 is thus highly efficient at removing sand from slurry material obtained from a dairy operation.

### IV. Example Two-Stage Separation System

FIG. 7 illustrates a fourth example separation system 420 comprising a primary separator 422, a first secondary separator 424, and a second secondary separator 426. The example primary separator 422 is or may be the system disclosed in the Applicant's copending U.S. patent application Ser. Nos. 13/351,214 and 13/926,640. The first and second secondary separators 424 and 426 may be the same as the first example separation system 20 described above. The primary separator 422 and the first and second secondary separators 424 and 426 will be described again herein only to that extent necessary for a complete understanding of the principles of the present invention.

The first stage separator 422 comprises a processing system 430, a trough system 432, and a drive system (not visible in FIG. 7) and defines a primary inlet 440, a first primary outlet 442, and a second primary outlet 444. Relatively clean sand exits the processing system 430 through the first primary outlet 442. A first secondary feed material is removed from the processing system 430 through a first secondary conduit 450 connected between the second primary outlet 444 and a first secondary inlet 452 of the first secondary separator 424. In addition, a second secondary feed material is removed directly from the trough system 432 through a second secondary conduit 454 connected between the trough system 432 and a second secondary inlet 456 of the second secondary separator 426.

The first secondary inlet 452 and the second secondary inlet 456 may be the same as the main inlet 130 of the first example separation system 20 described above. The secondary feed materials will thus be processed by the first and second secondary separators 424 and 426 in the same manner as the feed material processed by the first example separation system 20 to remove sand from the first and second secondary feed materials, respectively. The combination of the primary separator 422 with the first and second secondary separators 424 and 426 is thus highly efficient at removing sand from slurry material obtained from a dairy operation.

### V. Example Two-Stage Separation System

FIG. 8 illustrates a fifth example separation system 520 comprising a primary separator 522 and a secondary separator 524. The example primary separator 522 is or may be the system disclosed in the Applicant's copending U.S. patent application Ser. Nos. 13/351,214 and 13/926,640. The secondary separator 524 may be the same as the first example separation system 20 described above. The primary separator 522 and the secondary separator 524 will be described again herein only to that extent necessary for a complete understanding of the principles of the present invention.

The first stage separator 522 comprises a processing system 530, a trough system 532, and a drive system (not visible in FIG. 8) and defines a primary inlet 540, a first primary outlet 542, and a second primary outlet 544. Relatively clean sand exits the processing system 530 through the first primary outlet 542. A first secondary feed material is removed from the processing system 530 through a first secondary conduit 550 connected between the second primary outlet 544 and a secondary inlet 552 of the second stage separator 524. In addition, a second secondary feed material is removed from the processing system 530 through a second secondary conduit 554 connected between the trough system 532 and the secondary inlet 552.

The first secondary inlet 552 may be the same as the main inlet 130 of the first example separation system 20 described above. Accordingly, the secondary feed material will thus be processed in the same manner as the feed material processed by the first example separation system 20 to remove sand from the secondary feed material. The combination of the primary separator 522 with the secondary separator 524 is thus highly efficient at removing sand from slurry material obtained from a dairy operation.

### VI. Example Two-Stage Separation System

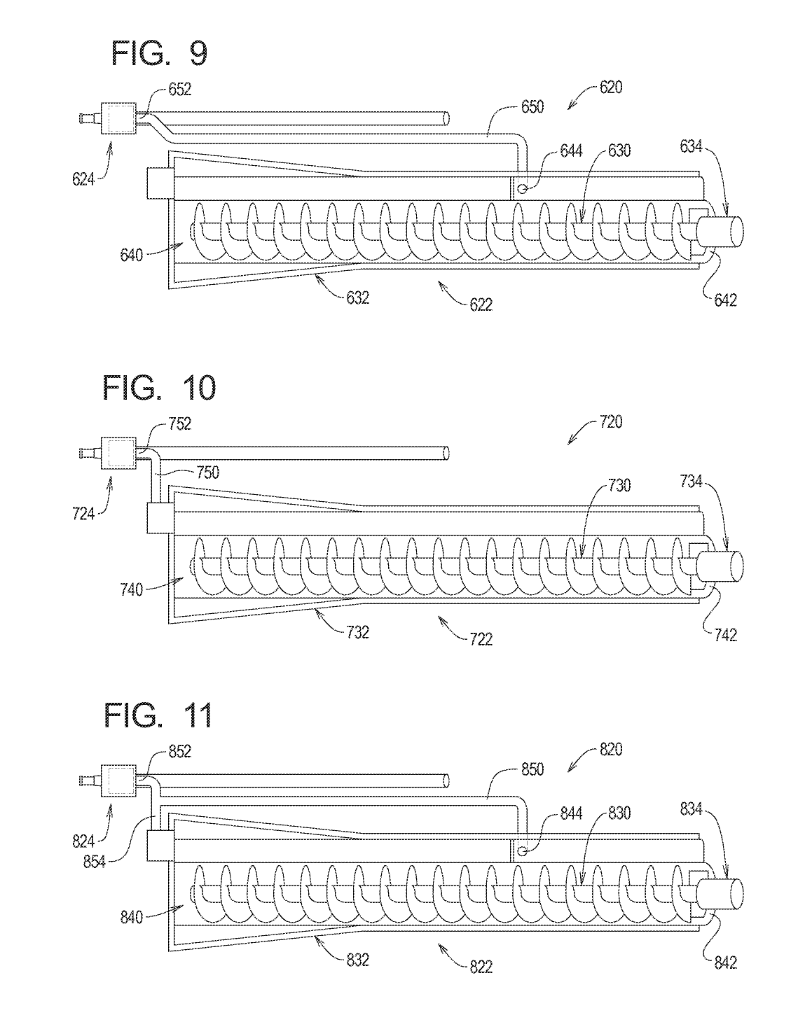

FIG. 9 illustrates a sixth example separation system 620 comprising a primary or first stage separator 622 and a secondary or second stage separator 624. In the sixth example separation system 620, the example first stage or primary separator 622 is a modified version of a sand separator for a dairy facility sold by McLanahan Corporation of Hollidaysburg, Pa. and generally disclosed in U.S. Pat. No. 5,950,839 to Wedel. The example second stage or secondary separator 624 is the first example separation system 20 described above. The first and second stage separators 622 and 624 will be described again herein only to that extent necessary for a complete understanding of the principles of the present invention.

The first stage separator 622 comprises a processing system 630, a trough system 632, and a drive system 634 and defines a primary inlet 640, a first primary outlet 642, and a second primary outlet 644. Again, relatively clean sand exits the processing system 630 through the first primary outlet 642. In the sixth example separation system 620, a secondary feed material is carried from the primary separator 622 to the secondary separator 624 by a first conduit 650 connected between the second primary outlet 644 and a secondary inlet 652 of the secondary separator 624.

The secondary inlet 652 may be the same as the main inlet 130 of the first example separation system 20 described above. The secondary feed material will thus be processed in the same manner as the feed material processed by the first example separation system 20 to remove sand from the secondary feed material. The combination of the primary and secondary separators 622 and 624 is thus efficient at removing sand from slurry material obtained from a dairy operation.

### VII. Example Two-Stage Separation System

FIG. 10 illustrates a seventh example separation system 720 comprising a primary or first stage separator 722 and a secondary or second stage separator 724. Again, the example first stage or primary separator 722 is a modified version of a sand separator for a dairy facility sold by McLanahan Corporation of Hollidaysburg, Pa. and generally disclosed in U.S. Pat. No. 5,950,839 to Wedel. The example second stage or secondary separator 724 is the first example separation system 20 described above. The first and second stage separators 722 and 724 will be described again herein only to that extent necessary for a complete understanding of the principles of the present invention.

The first stage separator 722 comprises a processing system 730, a trough system 732, and a drive system 734 and defines a primary inlet 740 and a first primary outlet 742. Again, relatively clean sand exits the processing system 730 through the first primary outlet 742. A secondary feed material is carried from the primary separator 722 to the secondary separator 724 by a first conduit 750 connected between the trough system 732 and a secondary inlet 752 of the secondary separator 724.

The secondary inlet 752 may be the same as the main inlet 130 of the first example separation system 20 described above. The secondary feed material will thus be processed in the same manner as the feed material processed by the first example separation system 20 to remove sand from the secondary feed material. The combination of the primary and secondary separators 722 and 724 is thus efficient at removing sand from slurry material obtained from a dairy operation.

### VIII. Example Two-Stage Separation System

FIG. 11 illustrates an eighth example separation system 820 comprising a primary or first stage separator 822 and a secondary or second stage separator 824. In the eighth example separation system 820, the example first stage or primary separator 822 is a modified version of a sand separator for a dairy facility sold by McLanahan Corporation of Hollidaysburg, Pa. and generally disclosed in U.S. Pat. No. 5,950,839 to Wedel. The example second stage or secondary separator 824 is the first example separation system 20 described above. The first and second stage separators 822 and 824 will be described again herein only to that extent necessary for a complete understanding of the principles of the present invention.

The first stage separator 822 comprises a processing system 830, a trough system 832, and a drive system 834 and defines a primary inlet 840, a first primary outlet 842, and a second primary outlet 844. Again, relatively clean sand exits the processing system 830 through the first primary outlet 842. In the eighth example separation system 820, a first secondary feed material is carried from the primary separator 822 to the secondary separator 824 by a first conduit 850 connected between the second primary outlet 844 and a secondary inlet 852 of the secondary separator 824. In addition, a second secondary feed material is carried from the primary separator 822 to the secondary separator 824 by a second conduit 854 connected between the trough system 832 and the secondary inlet 852 of the secondary separator 824.

The secondary inlet 852 may be the same as the main inlet 130 of the first example separation system 20 described above. The secondary feed material will thus be processed in the same manner as the feed material processed by the first example separation system 20 to remove sand from the secondary feed material. The combination of the primary and secondary separators 822 and 824 is thus efficient at removing sand from slurry material obtained from a dairy operation.

The eighth example separator system may be modified by using a second secondary separator. If first and second secondary separators are provided, the inlet 852 of the first secondary separator 824 is connected to the first conduit 850, and the inlet of the second secondary separator is connected to the second conduit 854.

What is claimed is:

1. A separation system for separating solids from a slurry of waste material, the separation system comprising:
a first separator assembly comprising a main housing and a perforated drum supported for rotation relative to the main housing; and
a second separator assembly comprising a barrel member and an auger blade supported for rotation relative to the barrel member; whereby
the main housing is fixed relative to the barrel member such that
rotation of the perforated drum removes a first solids portion from the slurry of waste material, and
rotation of the auger member removes a second solids portion from the slurry of waste material.

2. A separation system as recited in claim 1, in which:
the main housing is fixed to the barrel member to define an auger hopper;
the auger hopper is arranged relative to the perforated drum such that at least a portion of the slurry of waste material enters the auger hopper; and
the auger blade is arranged at least partly within the auger hopper.

3. A separation system as recited in claim 1, in which:
the main housing defines a main inlet and a main outlet; and
the barrel member defines an auger outlet; whereby
the slurry of waste material enters the perforated drum through the main inlet;
the first solids portion and the slurry of waste material passes through the main outlet; and
the second solids portion passes through the auger outlet.

4. A separation system as recited in claim 1, further comprising a rinse system for applying rinse liquid to the slurry of waste material within the perforated drum.

5. A separation system as recited in claim 4, in which:
the main housing is fixed to the barrel member to define an auger hopper;
the auger hopper is arranged relative to the perforated drum such that at least a portion of the slurry of waste material and at least a portion of the rinse liquid enters the auger hopper; and
the auger blade is arranged at least partly within the auger hopper.

6. A separation system as recited in claim 4, in which:
the main housing defines a main inlet and a main outlet; and
the barrel member defines an auger outlet; whereby
the slurry of waste material enters the perforated drum through the main inlet;
the first solids portion, the slurry of waste material, and at least a portion of the rinse liquid passes through the main outlet; and
the second solids portion passes through the auger outlet.

7. A separation system as recited in claim 1, further comprising a primary separation assembly, whereby:
the primary separation assembly removes a primary solids portion from slurry of waste material; and
the primary separation assembly is arranged relative to the first separation assembly such that the slurry of waste material flows from the primary separation assembly into the perforated drum after removal of the primary solids portion.

8. A method of separating solids from a slurry of waste material comprising the steps of
supporting a perforated drum for rotation relative to a main housing;
supporting an auger blade for rotation relative to a barrel member;
supporting the main housing relative to the barrel member;
rotating the perforated drum relative to the housing to remove a first solids portion from the slurry of waste material; and
rotating the auger member relative to the barrel member to remove a second solids portion from the slurry of waste material.

9. A method as recited in claim 8, in which the step of supporting the main housing relative to the barrel member comprises the steps of:
securing the main housing to the barrel member to define an auger hopper;
arranging the auger hopper relative to the perforated drum such that at least a portion of the slurry of waste material enters the auger hopper; and
arranging the auger blade at least partly within the auger hopper.

10. A method as recited in claim 8, in which:
the slurry of waste material enters the perforated drum through a main inlet defined by the main housing;
the first solids portion and the slurry of waste material passes through a main outlet defined by the main housing; and
the second solids portion passes through an auger outlet defined by the barrel member.

11. A method as recited in claim 8, further comprising the step of applying rinse liquid to the slurry of waste material within the perforated drum.

12. A method as recited in claim 11, in which the step of supporting the main housing relative to the barrel member comprises the steps of:
securing the main housing to the barrel member to define an auger hopper;
arranging the auger hopper relative to the perforated drum such that at least a portion of the slurry of waste material and at least a portion of the rinse liquid enters the auger hopper; and
arranging the auger blade at least partly within the auger hopper.

13. A method as recited in claim 11, in which:
the slurry of waste material enters the perforated drum through a main inlet defined by the main housing;
the first solids portion and the slurry of waste material and at least a portion of the rinse liquid passes through a main outlet defined by the main housing; and
the second solids portion passes through an auger outlet defined by the barrel member.

14. A method as recited in claim 8, further comprising the steps of:
removing a primary solids portion from slurry of waste material; and
allowing the slurry of waste material to flow into the perforated drum after removal of the primary solids portion.

15. A separation system for separating solids from a slurry of waste material, the separation system comprising:
a first separator assembly comprising
a main housing,
a perforated drum, and
a drum motor for causing axial rotation of the perforated drum relative to the main housing; and
a second separator assembly comprising
a barrel member,
an auger shaft,
an auger blade extending from the auger shaft, and
a barrel motor for causing axial rotation of the auger shaft relative to the barrel member; and
a rinse system; whereby
the rinse system mixes rinse liquid with the slurry of waste material within the perforated drum;
rotation of the perforated drum removes a first solids portion from the slurry of waste material;
the main housing is fixed relative to the barrel member to define an auger chamber arranged relative to the perforated drum such that at least a portion of the slurry of waste material and at least a portion of the rinse liquids enters the auger hopper; and
the auger blade is arranged at least partly within the auger hopper such that rotation of the auger member removes a second solids portion from the slurry of waste material.

16. A separation system as recited in claim 15, in which:
the main housing defines a main inlet and a main outlet; and
the barrel member defines an auger outlet; whereby
the slurry of waste material enters the perforated drum through the main inlet;
the first solids portion, the slurry of waste material, and at least a portion of the rinse liquid passes through the main outlet; and
the second solids portion passes through the auger outlet.

17. A separation system as recited in claim 15, further comprising a primary separation assembly, whereby:
the primary separation assembly removes a primary solids portion from slurry of waste material; and
the primary separation assembly is arranged relative to the first separation assembly such that the slurry of waste material flows from the primary separation assembly into the perforated drum after removal of the primary solids portion.

18. A separation system as recited in claim 17, further comprising a primary separation assembly, whereby:
the primary separation assembly removes a primary solids portion from slurry of waste material; and
the primary separation assembly is arranged relative to the first separation assembly such that the slurry of waste material flows from the primary separation assembly, through the main inlet, and into the perforated drum after removal of the primary solids portion.
